(19) United States
(12) Patent Application Publication
(10) Pub. No.: US 2018/0232565 A1
(43) Pub. Date: Aug. 16, 2018

(54) TERMINAL CONTROL SYSTEM, CONTROLLER, AND TERMINAL CONTROL METHOD

(71) Applicant: PANASONIC INTELLECTUAL PROPERTY MANAGEMENT CO., LTD., Osaka (JP)

(72) Inventors: Ryoji KOGA, Osaka (JP); Seiji FURUSAWA, Osaka (JP); Yuki UEDA, Osaka (JP); Akira WATANABE, Kanagawa (JP); Keiji MORI, Osaka (JP)

(21) Appl. No.: 15/788,400

(22) Filed: Oct. 19, 2017

Related U.S. Application Data
(63) Continuation of application No. PCT/JP2017/004849, filed on Feb. 10, 2017.

(51) Int. Cl. G06K 9/00; G06K 9/62; B64D 11/00

(52) U.S. Cl. CPC G06K 9/00288; G06K 9/628; G06F 3/1423; G06K 2009/00322; B64D 11/00151

(57) ABSTRACT

A terminal control system includes a plurality of terminals and a controller which controls the plurality of terminals. Each of the plurality of terminals includes an imager which images a user of the terminal to generate image data. The controller includes: a storage which stores group information indicating grouping of the plurality of terminals; a classifier which classifies each of target terminals included in a same group indicated by the group information among the plurality of terminals into a first group or a second group, based on the image data generated by the imager of the target terminal; and a setter which performs settings of a first type terminal classified into the first group and a second type terminal classified into the second group so that the first type terminal can control the second type terminal.

### CROSS REFERENCE TO RELATED APPLICATION

This application is a U.S. continuation application of PCT International Patent Application Number PCT/JP2017/004849 filed on Feb. 10, 2017, the entire content of which is hereby incorporated by reference.

### BACKGROUND

### 1. Technical Field

The present disclosure relates to a terminal control system which controls a plurality of terminals, a controller, and a terminal control method.

### 2. Description of the Related Art

Systems using a plurality of terminals have been conventionally known (for example, see Japanese Unexamined Patent Application Publication No. 2009-286343).

### SUMMARY

It is desired for such systems using terminals to differentiate and control the terminals according to characteristics of users of the respective terminals.

In view of this, the present disclosure has an object to provide a terminal control system and a terminal control method which make it possible to classify a plurality of terminals used in a terminal control system into different groups according to characteristics of users of the respective terminals.

A terminal control system according to an aspect of the present disclosure is a terminal control system including: a plurality of terminals; and a controller which controls the plurality of terminals, wherein each of the plurality of terminals includes an imager which images a user of the terminal to generate image data, the controller includes: a storage which stores group information indicating grouping of the plurality of terminals; a classifier which classifies each of target terminals included in a same group indicated by the group information among the plurality of terminals into a first group or a second group, based on the image data generated by the imager of the target terminal; and a setter which performs settings of a first type terminal classified into the first group and a second type terminal classified into the second group so that the first type terminal can control the second type terminal.

A controller according to an aspect of the present disclosure is a controller which controls a plurality of terminals including an imager, including: a storage which stores group information indicating grouping of the plurality of terminals; a classifier which classifies each of target terminals included in a same group indicated by the group information among the plurality of terminals into a first group or a second group, based on the image data generated by the imager of the target terminal; and a setter which performs settings of a first type terminal classified into the first group and a second type terminal classified into the second group so that the first type terminal can control the second type terminal.

A method for controlling a plurality of terminals according to an aspect of the present disclosure is a method for controlling a plurality of terminals each including an imager, the control method including: storing group information indicating grouping of the plurality of terminals; classifying each of target terminals included in a same group indicated by the group information among the plurality of terminals into a first group or a second group, based on the image data generated by the imager of the target terminal; and performing settings of a first type terminal classified into the first group and a second type terminal classified into the second group so that the first type terminal can control the second type terminal.

The terminal control system and the terminal control method make it possible to classify the plurality of terminals used in the terminal control system into the different groups according to the characteristics of the users of the respective terminals.

### BRIEF DESCRIPTION OF DRAWINGS

These and other objects, advantages and features of the disclosure will become apparent from the following description thereof taken in conjunction with the accompanying drawings that illustrate a specific embodiment of the present disclosure.

FIG. 1 is a perspective view showing an arrangement of in-flight monitors provided in the cabin of an airplane according to an embodiment;

FIG. 2 is a block diagram illustrating a configuration of an in-flight system according to the embodiment and a management system of an airplane company which communicates with the in-flight system;

FIG. 3 is a block diagram illustrating a configuration of a server according to the embodiment;

FIG. 4 is a block diagram illustrating a configuration of an in-flight monitor according to the embodiment;

FIG. 5 is a block diagram illustrating a configuration of functions provided by the in-flight system according to the embodiment;

FIG. 6 is a flowchart of operations in the in-flight system according to the embodiment;

FIG. 7 is a sequence diagram illustrating operations in the in-flight system according to the embodiment;

FIG. 8 is a schematic diagram of a manager menu according to the embodiment;

FIG. 9 is a data configuration diagram of first management information according to the embodiment;

FIG. 10 is a data configuration diagram of a determination message according to the embodiment; and

FIG. 11 is a data configuration diagram of a lock control message according to the embodiment.

### DETAILED DESCRIPTION OF THE EMBODIMENTS

A terminal control system according to an aspect of the present disclosure includes: a storage which stores group information indicating grouping of the plurality of terminals; a plurality of imagers of the respective terminals, each of which images a user of the terminal to generate image data; a classifier which classifies each of classification target terminals included in a same group indicated by the group information among the plurality of terminals into a first group or a second group, based on the image data generated by the imager of the classification target terminal included in the same group; and a setter which performs settings of a first type terminal classified into the first group and a second type terminal classified into the second group so that the first type terminal can control the second type terminal.

The terminal control system having the above configuration makes it possible to classify the plurality of terminals used in the terminal control system into the different groups according to the characteristics of the users of the respective terminals.

In addition, in the classification, the classifier may estimate the age of the user of the classification target terminal based on the image data generated by the imager of the classification target terminal, and classifies the classification target terminal into the first group when the age falls within a predetermined range, and classifies the classification target terminal into the second group when the age falls outside the predetermined range.

In this way, it is possible to classify the terminals according to the estimated ages of the users of the respective terminals.

In addition, the setter may perform the setting so that the first type terminal notifies the user of the terminal that the target terminal is the first type terminal.

In this way, each user of the terminal classified to be the first type terminal can recognize that his or her terminal is the first type terminal.

In addition, the setter may perform the setting for allowing the user of the first type terminal to perform remote control of at least one of functions of the second type terminal by using the first type terminal.

In this way, the user of the first type terminal can operate the second terminal at a place apart from the second type terminal.

In addition, the setter may perform the setting for allowing the user of the first type terminal to limit at least one of functions of the second type terminal by using the first type terminal.

In this way, the user of the first type terminal can prevent the user of the second type terminal from executing some processing using the second type terminal.

In addition, the plurality of terminals may be respectively arranged in transport equipment in one-to-one association with a plurality of seats provided in the transport equipment.

In this way, the plurality of terminals can be operated in the system whose users are passengers of the transport equipment.

A method for controlling a plurality of terminals according to an aspect of the present disclosure is a method for controlling a plurality of terminals each including a storage, a plurality of imagers of the respective terminals, a classifier, and a setter, the control method including: storing, in the storage, group information indicating grouping of the plurality of terminals; images a user of each target terminal included in a same group among the plurality of terminals, by the corresponding imager to generate image data; classifying each target terminal included in the same group indicated by the group information into a first group or a second group, based on the image data generated by the imager of the target terminal; and performing settings of a first type terminal classified into the first group and a second type terminal classified into the second group so that the first type terminal can control the second type terminal.

The terminal control method configured as above makes it possible to classify the plurality of terminals used in the terminal control system into the different groups according to the characteristics of the users of the respective terminals.

These general and specific aspects may be implemented using a system, a method, an integrated circuit, a computer program, or a computer-readable recording medium such as a CD-ROM, or any combination of systems, methods, integrated circuits, computer programs, or computer-readable recording media.

Hereinafter, an embodiment is described in detail referring to the drawings as necessary. It is to be noted that unnecessarily detailed descriptions may be omitted. For example, detailed descriptions of well-known matters and overlapping descriptions of substantially the same constituent elements may be omitted. This omission is made to prevent the following descriptions from being unnecessarily redundant and help the person skilled in the art appreciate the present disclosure.

It is to be noted that the attached drawings and the descriptions below are provided to help the person skilled in the art fully appreciate the present disclosure, and thus are not intended to limit the scope of the claims.

### Embodiment

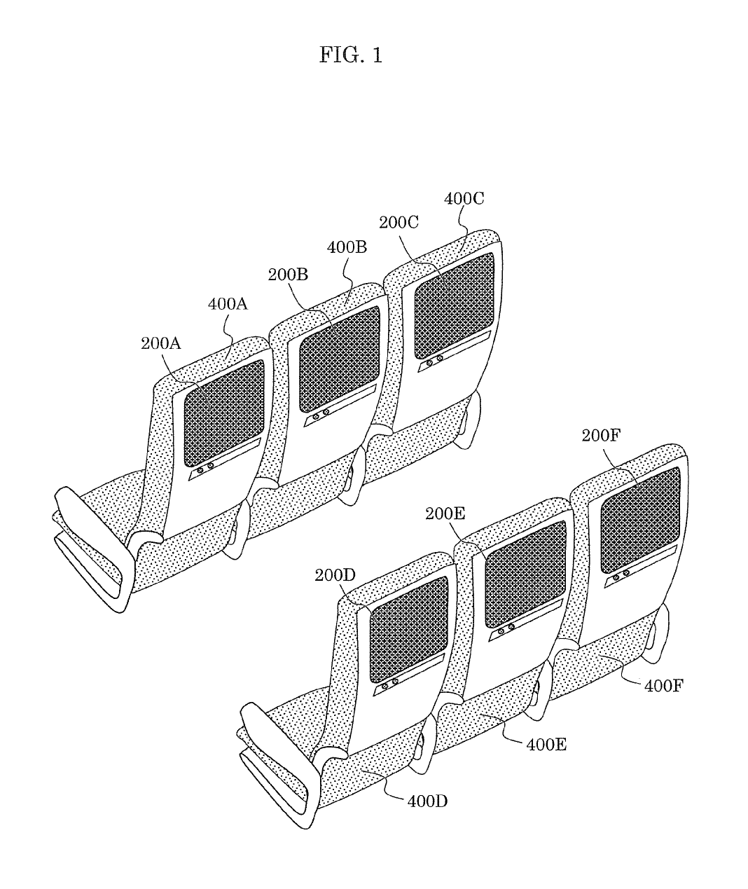

Hereinafter, an embodiment is described with reference to FIG. 1 to FIG. 11.

### [1-1 Configuration]

A terminal control system according to this embodiment of the present disclosure is implemented as an in-flight system provided in an airplane.

Hereinafter, a configuration of the in-flight system is described with reference to FIGS. 1 to 5.

FIG. 1 is a diagram of an arrangement of in-flight monitors 200A to 200F provided in an airplane according to this embodiment. The airplane has a plurality of seats 400A to 400F for passengers. Seats 400A to 400F may also be referred to as seats 400. In-flight monitors 200A to 200F are mounted at predetermined positions on the backside surfaces of the backrests of seats 400A to 400F. In-flight monitors 200A to 200F have the same configuration. In-flight monitors 200A to 200F may also be referred to as in-flight monitors 200.

As illustrated in FIG. 1, in-flight monitors 200 are arranged correspondingly to seats 400. More specifically, in-flight monitors 200 are mounted at positions facing passengers who sit down on seats 400 in such a manner that in-flight monitors 200 can be visually recognized by the passengers. Each passenger on seat 400 can operate a touch panel (described later) of in-flight monitor 200 on the back of seat 400 immediately before his or her seat 400 and appreciate video displayed on in-flight monitor 200, and can thereby receive various kinds of in-flight services. It is to be noted that the airplane is an example of transport equipment.

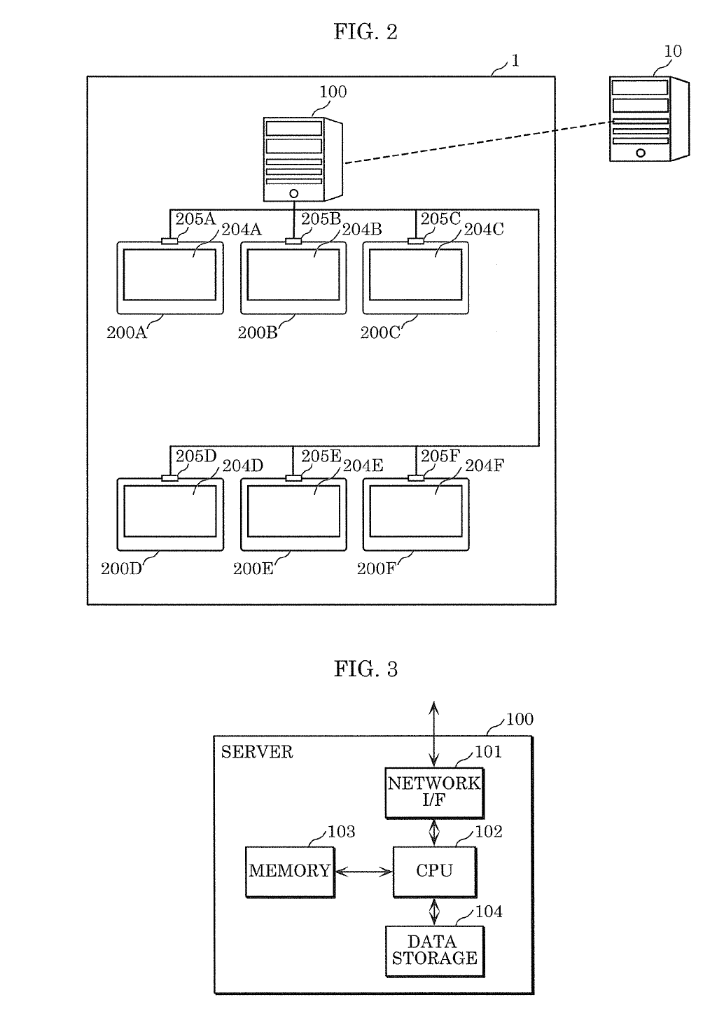

FIG. 2 is a diagram illustrating a configuration of in-flight system 1 and management system 10 of an airplane company which communicates with in-flight system 1.

As illustrated in the diagram, in-flight system 1 includes: server 100; and in-flight monitors 200A to 200F.

Management system 10 of the airplane company is connected to server 100 via a wireless network.

Server 100 is connected to in-flight monitor 200 with a network cable, and performs interactive communications with in-flight monitor 200. The interactive communications include, for example, to distribute content to in-flight monitor 200, and to obtain information regarding the connection state of communication with in-flight monitor 200. Pieces of information such as the information regarding the connection state of communication by in-flight monitor 200 are collectively managed by server 100.

In-flight monitor 200 is capable of playing back content distributed from server 100. In-flight monitors 200A to 200F include touch panels 204A to 204F and camera modules 205A to 205F, respectively. Touch panels 204A to 204F may be also referred to as touch panels 204. Camera modules 205A to 205F may be also referred to as camera modules 205.

Although a configuration in which six in-flight monitors 200 are connected to server 100 is described as an example in this embodiment, the number of in-flight monitors is not limited thereto and any other numbers are possible.

Each camera module 205 is disposed at a position which faces the face of a passenger sitting down on the seat so as to image his or her face in a frontal view.

FIG. 3 is a block diagram illustrating a configuration of server 100. Server 100 includes: network interface (I/F) 101; CPU 102; memory 103; and data storage 104.

Network interface 101 is an interface for allowing CPU 102 to communicate with in-flight monitor 200 via a network cable.

CPU 102 executes a program stored in memory 103, and performs various kinds of operations and information processing. CPU 102 is capable of reading from and writing in memory 103 and data storage 104. In addition, CPU 102 communicates with in-flight monitor 200 via network interface 101. CPU 102 receives an estimated-age parameter transmitted from each in-flight monitor 200, and issues a function control command to each in-flight monitor 200 according to a sequence described later.

Memory 103 stores a program which is executed by CPU 102 and the result of operation by CPU 102. Memory 103 is configured with, for example, a flash memory or a RAM.

Data storage 104 stores content, first management information (described later) and second management information (described later) of each seat. Each seat 400 has a seat number. Server 100 holds information relating to in-flight monitor 200 on each seat 400 and the association with the seat number. Data storage 104 is configured with, for example, a hard disc or a flash memory. Data storage 104 is an example of a storage device.

First management information includes information relating to grouping of in-flight monitor 200, information for classifying in-flight monitors 200 into a master terminal and a slave terminal, and information for allowing the master terminal to control the slave terminal.

Second management information is an association list indicating the association between in-flight monitor 200 which performs remote control and target in-flight monitor 200 to be subjected to the remote control. Second management information is required for the master terminal to perform remote control of the slave terminal.

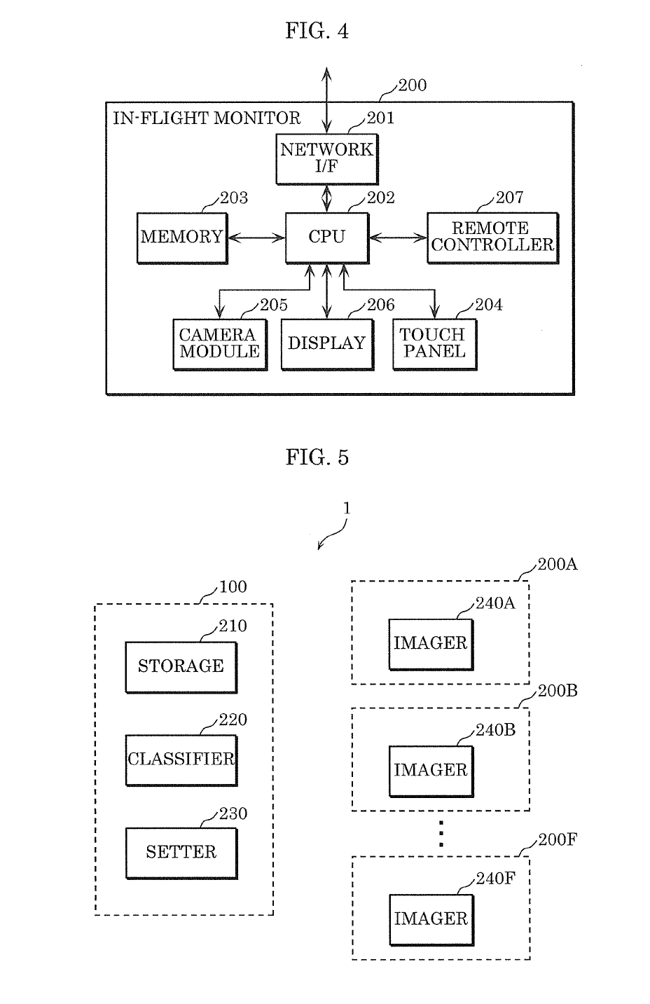

FIG. 4 is a block diagram illustrating a configuration of in-flight monitor 200. In-flight monitor 200 includes: network interface (I/F) 201; CPU 202; memory 203; touch panel 204; camera module 205; display 206; and remote controller 207.

Network interface 201, CPU 202, and memory 203 are hardware items respectively similar to network interface 101, CPU 102, and memory 103 of server 100.

Network interface 201 is an interface for allowing CPU 202 to communicate with server 100 via a network cable.

CPU 202 is capable of executing a program stored in memory 203 to perform various kinds of operation and information processing, and perform reading from and writing in memory 203. In addition, CPU 202 communicates with server 100 via network interface 201. Memory 203 stores a program which is executed by CPU 202 and the result of operation by CPU 202.

Touch panel 204 is disposed on the surface of display 206. When a passenger touches display 206, information indicating the touched position of touch panel 204 is transmitted to CPU 202. By means of CPU 202 performing control according to the information, the passenger can perform an intuitive operation.

Camera module 205 images the face of the passenger facing camera module 205 itself in a frontal view, and stores the image data into memory 203.

Display 206 displays various kinds of content according to commands from CPU 202.

Remote controller 207 includes various kinds of switches such as a cabin attendant (CA) call switch, a reading light switch for turning on and off a reading light, and transmits information indicating the turn-on or -off of each switch to CPU 202.

In-flight system 1 provides various functions by means of CPU 102 executing a program stored in memory 103 in server 100, and CPU 202 executing a program stored in memory 203 in in-flight monitor 200.

FIG. 5 is a block diagram illustrating a configuration of functions provided by in-flight system 1.

As illustrated in the diagram, in-flight system 1 includes functional blocks of storage 210, classifier 220, setter 230, and a plurality of imagers 240 (imagers 240A to 240F).

Storage 210 is implemented by means of, for example, CPU 102 executing a program stored in memory 103 to control an operation between CPU 102 and memory 103.

Classifier 220 is implemented by means of, for example, CPU 102 executing a program stored in memory 103 to control an operation between CPU 102 and memory 103.

Setter 230 is implemented by means of, for example, CPU 102 executing a program stored in memory 103 to control an operation between CPU 102 and memory 103.

Imager 240 is implemented by means of, for example, CPU 202 executing a program stored in memory 203 to control operations between CPU 202, memory 203, and camera module 205.

Storage 210 stores group information (in this example, passenger management information described later) indicating grouping of a plurality of terminals (in this example, in-flight monitor 200).

Each of imagers 240 of the respective terminals (in this example, in-flight monitors 200) images a user of the terminal (in this case, in-flight monitor 200) to generate image data.

Classifier 220 classifies terminals (in this example, in-flight monitors 200) included in the same group indicated by the group information of the group among the plurality of terminals into a first group (in this example, a master terminal group described later) and a second group (in this example, a slave terminal group described later), based on the imaged data generated by imagers 240 of the respective terminals (in this example, in-flight monitors 200) included in the same group.

Setter 230 performs settings of one or more first type terminals (in this example, in-flight monitors 200) and one or more second type terminals (in this example, in-flight monitors 200) so that the one or more first type terminals classified into the first group (in this example, the master terminal group) can control the one or more second type terminals classified into the second group (in this example, the slave terminal group).

### [1-2 Operations]

Operations by in-flight system 1 configured as above are described below.

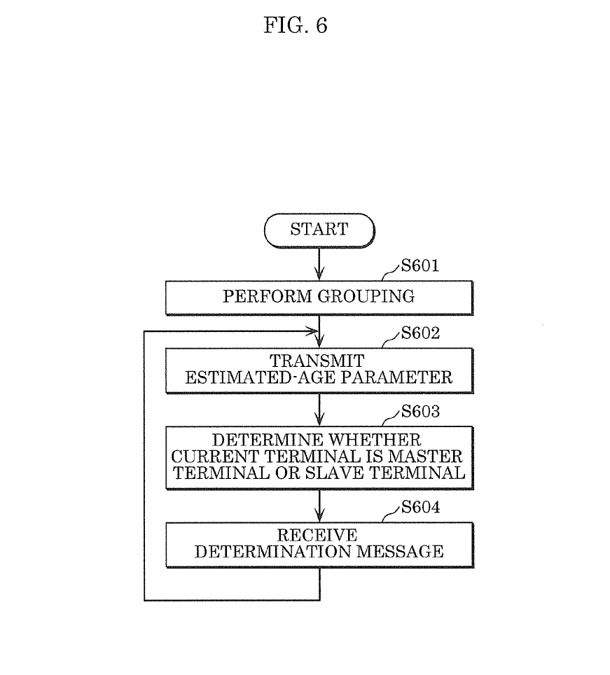

FIG. 6 is a flowchart for explaining operations by in-flight system 1.

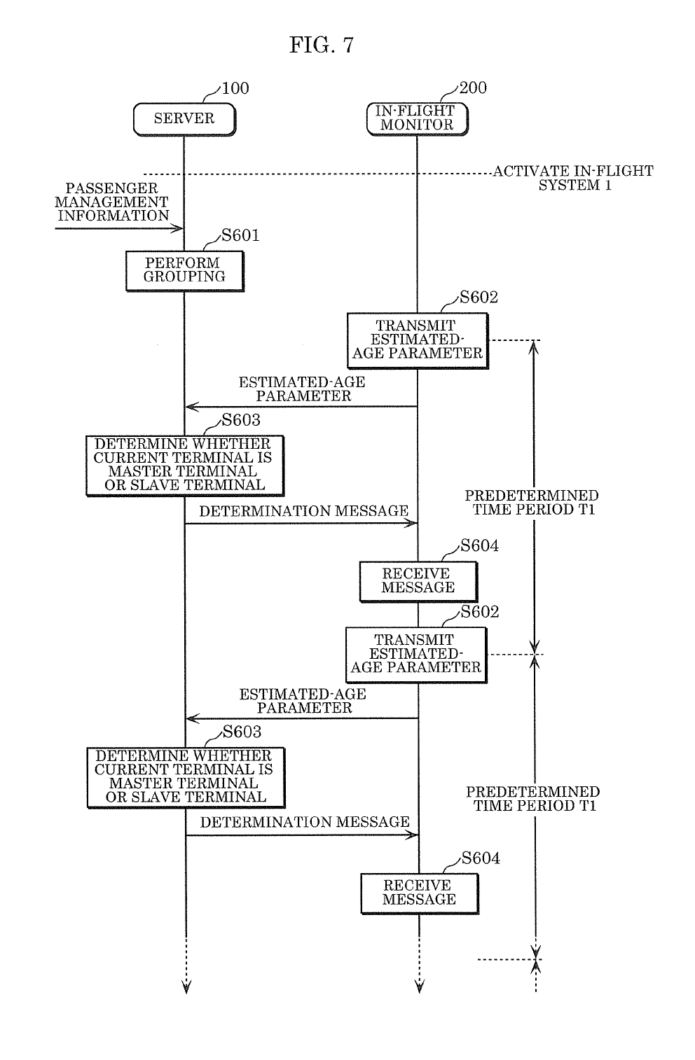

FIG. 7 is a sequence diagram for explaining operations by in-flight system 1.

In-flight system 1, when activated, obtains passenger management information from management system 10 of the airline company and stores the information. Based on the stored passenger management information, server 100 performs grouping of in-flight monitors 200. Server 100 determines, for each of in-flight monitors 200, whether current in-flight monitor 200 is a master terminal or a slave terminal based on an estimated-age parameter which is periodically transmitted from in-flight monitor 200, and transmits a determination message indicating the result of the determination to in-flight monitor 200. In-flight monitor 200 receives the determination message from server 100 to perform the operation corresponding to the determination message.

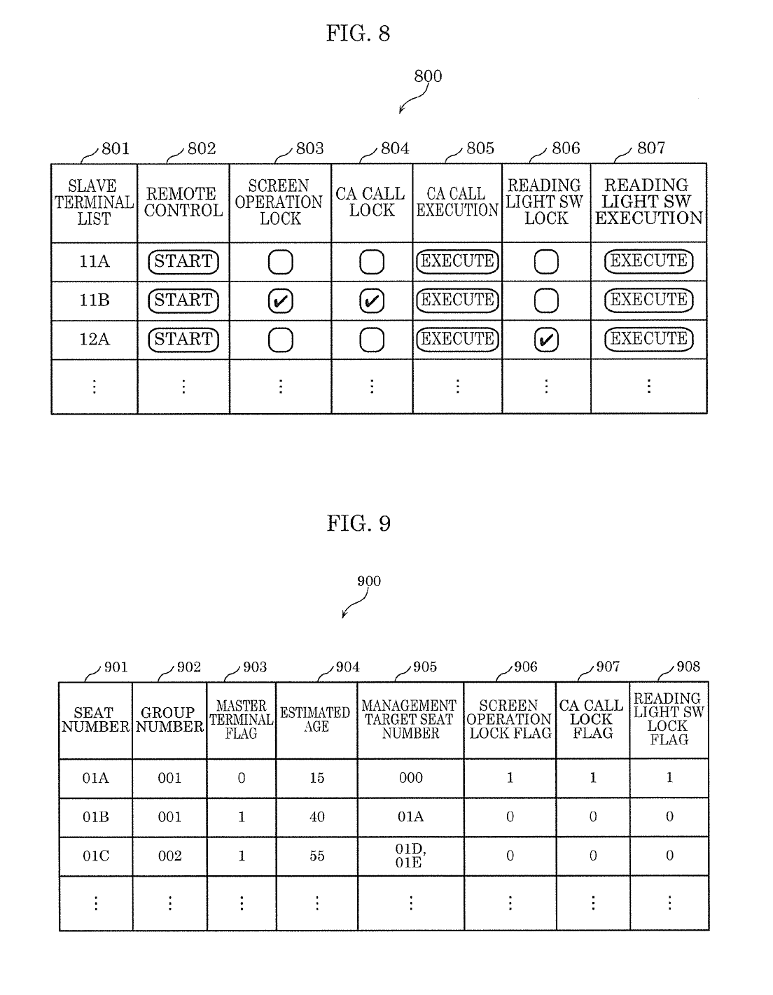

FIG. 8 is a schematic diagram indicating manager menu 800 which is an example of a manager menu that can be displayed on in-flight monitor 200 determined to be the master terminal.

As illustrated in the diagram, manager menu 800 includes slave terminal list 801, remote control 802, screen operation lock 803, CA call lock 804, CA call execution 805, reading light switch lock 806, and reading light switch (SW) execution 807 all associated with one another.

Slave terminal list 801 is the seat numbers of the seats corresponding to in-flight monitors 200 determined to be slave terminals (in other words, determined to be non-master terminals) among in-flight monitors 200 classified into the same group.

Remote control 802 indicates start buttons for starting a remote operation of in-flight monitor 200 identified by corresponding slave terminal list 801.

Screen operation lock 803 indicates buttons for locking a screen operation on in-flight monitor 200 identified by corresponding slave terminal list 801. Here, to lock a screen operation on target in-flight monitor 200 means to disable a screen operation on target in-flight monitor 200 by target in-flight monitor 200 itself.

CA call lock 804 indicates buttons for locking a CA call operation on in-flight monitor 200 identified by corresponding slave terminal list 801. Here, to lock CA call operation on target in-flight monitor 200 means to disable a CA call operation on target in-flight monitor 200 by target in-flight monitor 200 itself.

CA call execution 805 indicates buttons for executing a CA call of in-flight monitor 200 identified by corresponding slave terminal list 801.

Reading light switch (SW) lock 806 indicates buttons for locking a reading light switch operation on in-flight monitor 200 identified by corresponding slave terminal list 801. Here, to lock a reading light switch operation on target in-flight monitor 200 means to disable a reading light switch operation on target in-flight monitor 200 by target in-flight monitor 200 itself.

Reading light switch execution 807 indicates buttons for locking reading light switch operation on in-flight monitor 200 identified by corresponding slave terminal list 801.

### [1-2-1 Grouping (Step S601)]

In-flight system 1 is activated before the airplane mounting in-flight system 1 starts a flight. When in-flight system 1 is activated, CPU 102 of server 100 obtains passenger management information of management system 10 of the airplane company via network interface 101. In other words, storage 210 stores passenger management information. Based on the information, CPU 102 executes grouping of in-flight monitors 200 for all of the seats for passengers.

Grouping used here means to perform grouping of in-flight monitors 200 for the respective seats in such a manner that the seats for family members are grouped into the same group.

CPU 102 stores the grouping result in data storage 104 as first management information.

FIG. 9 is a data configuration diagram of first management information 900 which is an example of the first management information.

As illustrated in the diagram, first management information 900 includes seat number 901, group number 902, master terminal flag 903, estimated age 904, management target seat number 905, screen operation lock flag 906, CA call lock flag 907, and reading light switch (SW) lock flag 908 all associated with one another.

Seat number 901 is a seat number corresponding to target in-flight monitor 200.

Group number 902 is the group number of the group into which target in-flight monitor 200 is classified.

Master terminal flag 903 is a flag indicating whether target in-flight monitor 200 is determined to be a master terminal or not.

Estimated age 904 is the estimated age of the user who uses target in-flight monitor 200.

Management target seat number 905 is the seat number of the seat of each of in-flight monitors 200 determined to be slave terminals (in other words, determined to be non-master terminals) among in-flight monitors 200 classified into the same group into which target in-flight monitor 200 determined to be the master terminal is classified.

Screen operation lock flag 906 is a flag indicating whether or not target in-flight monitor 200 is subjected to screen operation lock.

CA call lock flag 907 is a flag indicating whether or not target in-flight monitor 200 is subjected to CA call operation lock.

Reading light switch lock flag 908 is a flag indicating whether or not target in-flight monitor 200 is subjected to reading light switch lock.

In this step (Step S601), it is assumed that master terminal flag 903, estimated age 904, management target seat number 905, screen operation lock flag 906, CA call lock flag 907, and reading light switch lock flag 908 are set to initial values.

### [1-2-2 Transmission of Estimated-Age Parameter (Step S602)]

When grouping at the time when in-flight system 1 is activated is completed in server 100, in-flight system 1 repeatedly executes processing in Steps S602 to S604 for each predetermined time period T1 (for example, for each one second).

When in-flight system 1 is activated, CPU 202 in in-flight monitor 200 transmits an image data request signal to camera module 205 periodically at a one-second interval. In response, camera module 205 performs imaging to generate an image, and stores the image in memory 203. In other words, imager 240 images the user sitting down on the corresponding seat to generate the image data.

CPU 202 identifies a user face area in the image data stored in memory 203, calculates an estimated age of the user based on the identified face, and generates an estimated-age parameter indicating the estimated age. CPU 202 transmits the estimated-age parameter to server 100 via network interface 201.

### [1-2-3 Master Terminal or Slave Terminal Determination (Step S603)]

Upon receiving the estimated-age parameter from in-flight monitor 200, CPU 102 of server 100 updates first management information stored in data storage 104. When the estimated age indicated by the estimated-age parameter received from given in-flight monitor 200 falls within a predetermined range (for example, from 20 to 70 years old), given in-flight monitor 200 is determined to be a master terminal. When the estimated age indicated by the estimated-age parameter received from given in-flight monitor 200 falls outside the predetermined range, given in-flight monitor 200 is determined to be a slave terminal. Specifically, classifier 220 classifies in-flight monitors 200 included in the same group (in this example, in-flight monitors 200 corresponding to the seats for given family members into a first group (in this example, a master terminal group of one or more in-flight monitors 200 determined to be one or more master terminals) and a second group (in this example, a slave terminal group of one or more in-flight monitors 200 determined to be one or more slave terminals). More specifically, classification target in-flight monitors 200 for users whose estimated ages fall within the predetermined range are classified into the first group (master terminal group) and classification target in-flight monitors 200 for users whose estimated ages fall outside the predetermined range are classified into the second group (slave terminal group).

CPU 102 of server 100 updates master terminal flag(s) 903 corresponding to one or more in-flight monitors 200 determined to be one or more master terminals to 1, and master terminal flag(s) 903 corresponding to one or more in-flight monitors 200 determined to be one or more slave terminals to 0. Setter 230 performs settings of the one or more first type terminals and the one or more second type terminals so that the one or more first type terminals (in this example, in-flight monitors 200) classified into the first group (in this example, the master terminal group) can control the one or more second type terminals (in this example, in-flight monitors 200) classified into the second group (in this example, the slave terminal group).

After the settings, CPU 102 of server 100 transmits a determination message to each in-flight monitor 200 via network interface 101.

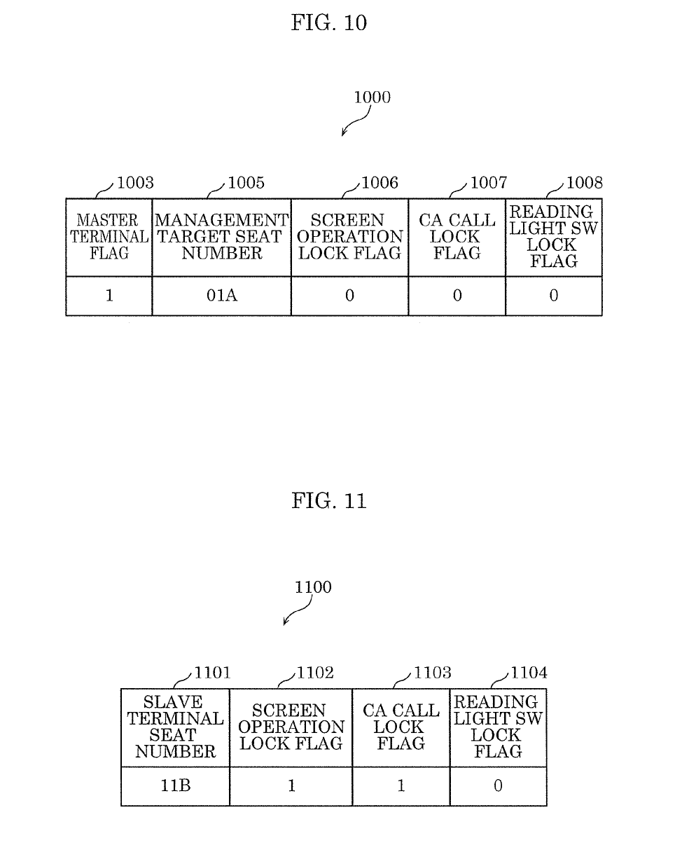

FIG. 10 is a data configuration diagram of determination message 1000 indicating the result of the determination which is an exemplary determination message.

As illustrated in the diagram, determination message 1000 includes master terminal flag 1003, management target seat number 1005, screen operation lock flag 1006, CA call lock flag 1007, and reading light switch (SW) lock flag 1008 associated with one another.

### [1-2-4 Reception of Determination Message (Step S604)]

Upon receiving determination message 1000 from server 100 via network interface 201, CPU 202 of in-flight monitor 200 executes processing for switching between display and non-display of a manager menu according to the parameter. More specifically, when the master terminal flag is 1, manager menu 800 in FIG. 8 is displayed. Manager menu 800 does not always need to be displayed, it is only necessary for manager menu 800 to be added as an item of the entire menu. When the master terminal flag is 0, manager menu 800 is not displayed.

Through the operations above, each in-flight monitor 200 is set to a master terminal or a slave terminal by server 100. Each in-flight monitor 200 operates as the master terminal or the slave terminal depending on the setting. Hereinafter, these operations are described.

### [1-2-5 Remote Screen Operation (Master Terminal)]

When in-flight monitor 200 is a master terminal, the functions of slave terminals displayed in slave terminal list 801 can be controlled from manager menu 800 of the master terminal.

First, an operation using remote control 802 is described.

When a start button of remote control 802 of manager menu 800 is pressed, CPU 202 of in-flight monitor 200 which displays manager menu 800 transmits a remote control start request to server 100. The remote control start request includes the seat number of the seat corresponding to in-flight monitor 200 which is a slave terminal to be subjected to the remote control. Upon receiving the remote control start request, CPU 102 of server 100 stores a pair of a master terminal and the target slave terminal to be subjected to the remote control as second management information in memory 103 or data storage 104. Based on the second management information, CPU 102 transmits a screen provision message to in-flight monitor 200 of the slave terminal. Upon receiving the screen provision message, CPU 202 of in-flight monitor 200 starts to transmit screen display data of display 206 to server 100 in real time. CPU 102 of server 100 transfers the screen display data to the master terminal in real time according to second management information. Upon receiving the screen display data, the master terminal displays the screen display data on display 206 as a screen of the slave terminal. The passenger on the seat can operate the screen of the slave terminal displayed on display 206 of the master terminal using touch panel 204 of the master terminal.

When the screen of the slave terminal displayed on display 206 of the master terminal is closed, CPU 202 transmits an end notification to server 100. Upon receiving the end notification, CPU 102 of server 100 deletes the pair (of the master terminal and the target slave terminal) from second management information, and transmits a remote screen end message to the target slave terminal. Upon receiving the remote screen end message, the slave terminal stops the real-time transmission of the display data displayed on display 206.

### [1-2-6 Function Locks (Master Terminal)]

Next, the function locks (screen operation lock 803, CA call lock 804, and reading light switch lock 806) on manager menu 800 are described. When any of the function locks is validated on manager menu 800, CPU 202 transmits a lock control message to server 100.

FIG. 11 is a data configuration diagram of determination message 1100 which is an exemplary lock control message.

As illustrated in the diagram, lock control message 1100 includes slave terminal seat number 1101, screen operation lock flag 1102, CA call lock flag 1103, and reading light switch lock flag 1104 associated with one another.

Upon receiving the lock control message, CPU 102 of server 100 transmits the lock execution message to in-flight monitor 200 corresponding to the slave terminal seat number. Upon receiving the lock execution message, CPU 202 of in-flight monitor 200 of the slave terminal stops, according to lock flags, receiving any of the following operations of: a touch on touch panel 204 (screen of the monitor itself), a press of the CA call lock button of remote controller 207 (for CA call from the monitor itself), and a switch of the reading light switch (switching of the reading light from the monitor itself).

### [1-2-7 Command Execution Buttons (Master Terminal)]

Next, descriptions are given of command execution buttons (for CA call execution 805 and reading light execution switch 807) on manager menu 800.

When an execute button of CA call execution 805 of manager menu 800 is pressed, CPU 202 of in-flight monitor 200 which displays manager menu 800 transmits a CA call execution request to server 100. The CA call execution request includes the seat number of the seat corresponding to in-flight monitor 200 which is a target slave terminal to be subjected to remote control. Upon receiving the CA call execution request, CPU 102 of server 100 transfers the CA call execution request to in-flight monitor 200 which is the target slave terminal. Upon receiving the CA call execution request, CPU 202 of in-flight monitor 200 executes the CA call.

When the execute button of reading light switch execution 807 of manager menu 800 is pressed, CPU 202 of in-flight monitor 200 which displays manager menu 800 transmits a reading light switch execution request to server 100. The reading light switch execution request includes the seat number of the seat corresponding to in-flight monitor 200 which is a target slave terminal. Upon receiving the reading light switch execution request, CPU 102 of server 100 transmits the reading light switch execution request to in-flight monitor 200 which is the target slave terminal. Upon receiving the reading light switch execution request, CPU 202 of in-flight monitor 200 executes a switch (ON or OFF) of the reading light switch.

### Other Embodiments

The above embodiment has been described as an example of techniques disclosed in the present application. However, techniques according to the present disclosure are not limited thereto, and are applicable to embodiments obtained by arbitrarily performing modification, replacement, addition, and omission on the techniques disclosed herein. In addition, it is also possible to configure a new embodiment by arbitrarily combining the constituent elements described in the above embodiment. Hereinafter, examples of other embodiments are provided.

(1) To perform grouping in Step S601 in the above embodiment has been described as to group in-flight monitors 200 for the passenger seats in such a manner that the seats for the family members are grouped into the same group. However, the grouping in Step S601 does not need to be limited to the grouping performed as described above. Conceivable examples of grouping using various approaches include grouping the passengers participated in the same tour into the same group.

(2) In the above embodiment, when two or more of in-flight monitors 200 grouped into the same group may be master terminals, and management menus 800 of the master terminals may be synchronized with each other.

(3) In the above embodiment, in-flight system 1 has been described as being configured to allow in-flight monitor 200 which is the master terminal to independently lock and execute the CA call operation on in-flight monitor 200 which is the slave terminal. In connection with this, as another example, in-flight system 1 may be configured to allow in-flight monitor 200 which is a master terminal to enable a CA call operation on in-flight monitor 200 which is a slave terminal only when any CA call operation on slave in-flight monitor 200 is locked.

In the above embodiment, in-flight system 1 has been described as being configured to allow in-flight monitor 200 which is the master terminal to independently lock and execute the reading light switch operation on in-flight monitor 200 which is the slave terminal. In connection with this, as another example, in-flight system 1 may be configured to allow in-flight monitor 200 which is a master terminal to perform a reading light switch operation on in-flight monitor 200 which is a slave terminal only when any reading light switch operation on slave in-flight monitor 200 is locked.

(4) In the above embodiment, the master terminal/slave terminal determination in Step S603 is performed in such a manner that current in-flight monitor 200 is determined to be the slave terminal when the estimated age indicated by the estimated-age parameter received by CPU 102 falls outside the predetermined range. In connection with this, as another conceivable example, when current in-flight monitor 200 is in-flight monitor 200 which has been determined to be a master terminal in the immediately-before master terminal/slave terminal determination, current in-flight monitor 200 may be determined to be a slave terminal only when the estimated age indicated by an estimated-age parameter received by CPU 102 falls outside a predetermined range N times in sequence (N is an integer of 2 or larger such as 10).

(5) In the above embodiment, when the processing in Step S604 has been completed, the return to Step S602 is made and the processing in Steps S602 to S604 is repeatedly executed. In connection with this, as another conceivable example, when the processing in Step S604 has been completed, a return to Step S601 is made and processing in Steps S601 to S604 is repeatedly executed. This example is especially useful when passenger management information is updated as appropriate in in-flight system 1 (for example, when a CA updates passenger management information each time when the seat of a passenger is changed in a flight of an airplane).

(6) In the above embodiment, CPU 202 of in-flight monitor 200 identifies passenger's face in the face area in the image data generated by camera module 205 and stored in memory 203, calculates the estimated-age based on the passenger's face, and generates the estimated-age parameter indicating the estimated age. CPU 102 of server 100 determines given in-flight monitor 200 to be the master terminal when the estimated age indicated by the estimated-age parameter received from given in-flight monitor 200 falls within the predetermined range, and determines given in-flight monitor 200 to be the slave terminal when the estimated age falls outside the predetermined range.

In contrast, for example, CPU 202 cannot identify passenger's face in a face area in image data (in the case where the passenger looks away, the passenger is not on the seat, or the like), CPU 202 generates an estimated-age parameter indicating a failure of face recognition. In this exemplary case, CPU 102 receives the estimated-age parameter indicating the failure of face recognition, and determines given in-flight monitor 200 to be a non-master terminal. To determine given in-flight monitor 200 to be a non-master terminal here is to determine given in-flight monitor 200 to be, for example, a slave terminal, a non-management-target device classified into a non-management-target device group other than the master terminal group and the slave terminal group.

(7) In this embodiment, as another conceivable example, in-flight system 1 may be configured to have a function for exchanging various kinds of settings made to a plurality of slave terminals when the slave terminals correspond to a given master terminal according to a user operation on the master terminal.

This example is especially useful when passengers using slave terminals exchange their seats in in-flight system 1.

(8) In the above embodiment, the device which receives the user operation inputs does not always need to be touch panel 204. For example, touch panel 204 may be replaced with a device that is a remote controller, keyboards, a mouse or the like.

In the above embodiment, in-flight system 1 does not always need to be provided in an airplane. For example, in-flight system 1 may be provided in transport equipment that is a train, a bus, or the like. Furthermore, in-flight system 1 may be provided in equipment such as a school room other than such transport equipment.

Although only some exemplary embodiments of the present disclosure have been described in detail above, those skilled in the art will readily appreciate that many modifications are possible in the exemplary embodiments without materially departing from the novel teachings and advantages of the present disclosure. Accordingly, all such modifications are intended to be included within the scope of the present disclosure.

### INDUSTRIAL APPLICABILITY

The present disclosure is widely applicable to systems using terminals.

What is claimed is:

1. A terminal control system, comprising:
a plurality of terminals; and
a controller which controls the plurality of terminals,
wherein each of the plurality of terminals includes
an imager which images a user of the terminal to generate image data,
the controller includes:
a storage which stores group information indicating grouping of the plurality of terminals;
a classifier which classifies each of target terminals included in a same group indicated by the group information among the plurality of terminals into a first group or a second group, based on the image data generated by the imager of the target terminal; and
a setter which performs settings of a first type terminal classified into the first group and a second type terminal classified into the second group so that the first type terminal can control the second type terminal.

2. The terminal control system according to claim 1,
wherein the classifier estimates an age of the user of a target terminal included in the same group based on the image data generated by the imager of the target terminal, and classifies the target terminal into the first group when the age falls within a predetermined range, and classifies the target terminal into the second group when the age falls outside the predetermined range.

3. The terminal control system according to claim 1,
wherein the setter performs the setting for notifying the target terminal classified into the first type terminal that the target terminal is the first type terminal.

4. The terminal control system according to claim 1,
wherein the setter performs the setting for allowing the first type terminal to perform remote control of at least one of functions of the second type terminal.

5. The terminal control system according to claim 1,
wherein the setter performs the setting for allowing the first type terminal to limit at least one of functions of the second type terminal.

6. The terminal control system according to claim 1,
wherein the plurality of terminals are arranged in transport equipment in one-to-one association with a plurality of seats provided in the transport equipment.

7. A controller which controls a plurality of terminals including an imager, comprising:
a storage which stores group information indicating grouping of the plurality of terminals;
a classifier which classifies each of target terminals included in a same group indicated by the group information among the plurality of terminals into a first group or a second group, based on the image data generated by the imager of the target terminal; and
a setter which performs settings of a first type terminal classified into the first group and a second type terminal classified into the second group so that the first type terminal can control the second type terminal.

8. The controller according to claim 7,
wherein the classifier estimates an age of the user of a target terminal included in the same group based on the image data generated by the imager of the target terminal, and classifies the target terminal into the first group when the age falls within a predetermined range, and classifies the target terminal into the second group when the age falls outside the predetermined range.

9. The controller according to claim 7,
wherein the setter performs the setting for notifying the target terminal classified into the first type terminal that the target terminal is the first type terminal.

10. The controller according to claim 7,
wherein the setter performs the setting for allowing the first type terminal to perform remote control of at least one of functions of the second type terminal.

11. The controller according to claim 7,
wherein the setter performs the setting for allowing the first type terminal to limit at least one of functions of the second type terminal.

12. A method for controlling a plurality of terminals each including an imager, the control method comprising:
storing group information indicating grouping of the plurality of terminals;
classifying each of target terminals included in a same group indicated by the group information among the plurality of terminals into a first group or a second group, based on the image data generated by the imager of the target terminal; and
performing settings of a first type terminal classified into the first group and a second type terminal classified into the second group so that the first type terminal can control the second type terminal.
